(19) United States
(12) Patent Application Publication
(10) Pub. No.: US 2019/0280640 A1
(43) Pub. Date: Sep. 12, 2019

(54) Method and System for Operating a Hybrid Power Generation System

(71) Applicant: General Electric Company, Schenectady, NY (US)

(72) Inventors: Govardhan Ganireddy, Roanoke, VA (US); Yashomani Yashodhan Kolhatkar, Bangalore (IN); Deepak Raj Sagi, Bangalore (IN)

(21) Appl. No.: 16/462,066

(22) PCT Filed: Nov. 6, 2017
(86) PCT No.: PCT/US2017/060121

§ 371 Date: May 17, 2019

(30) Foreign Application Priority Data
Nov. 17, 2016 (IN) 201641039303

(51) Int. Cl. H02S 10/12; H02J 3/38

(52) U.S. Cl. CPC H02S 10/12; H02S 50/00; H02J 3/386; H02J 3/383

(57) ABSTRACT

A method and a system (111) for operating a hybrid power generation system (100) are presented. the hybrid power generation system (100) includes a wind power generation system (102), a wind power controller (104), a photo-voltaic (PV) power generation system, and a PV power controller (108). The method includes determining a hybrid-level power demand of the hybrid power generation system (100). The method further includes determining respective power demand set-points of the wind power generation system (102) and the PV power generation system (106) based at least in part on the hybrid-level power demand. The method also includes communicating the power demand set-points of the wind power generation system (102) and the PV power generation system (106) respectively to at least one of the wind power controller (104) and the PV power controller (108). A farm (300) having a farm level control system (304) is also presented.

### BACKGROUND

Embodiments of the present invention generally relate to a hybrid power generation system and in particular, to method and system for operating a hybrid power generation system.

A wind based power generation is capable of converting kinetic energy of wind into electrical power. Currently, wind farms having different configurations are used to generate electrical power. Such farms may include wind turbine stations operable at a fixed speed, wind turbine stations performing full power conversion, and wind turbine stations performing partial power conversion. Additionally, solar/photo-voltaic (PV) based power generation systems may be used to generate electrical power based on solar irradiance.

For some applications, hybrid power generation systems are used. For example, such a hybrid power generation system includes both wind based power generation system and solar/photo-voltaic (PV) based power generation system to generate electrical power. The wind based power generation system and solar/photo-voltaic (PV) based power generation system generally share common balance of plant equipment (for example, a transformer). Typically, the wind based power generation system and the PV based power generation system are operated by respective controllers which operate independently of each other. In a hybrid power generation system, a net power generated by the wind based power generation system and the PV based power generation system needs to be lower than or equal to the maximum plant power limit of the hybrid power generation system. The maximum plant power limit can be determined by various factors such as the maximum rating of the balance of plant, curtailment, etc. Violating the maximum power limit may cause fluctuations in electrical power generated by the hybrid power generation system.

### BRIEF DESCRIPTION

In accordance with one embodiment of the present invention, a method for operating a hybrid power generation system is presented. The hybrid power generation system includes a wind power generation system coupled to a wind power controller and a photo-voltaic (PV) power generation system coupled to a PV power controller. The method includes determining a hybrid-level power demand of the hybrid power generation system. The method further includes determining respective power demand set-points of the wind power generation system and the PV power generation system based at least in part on the hybrid-level power demand. Furthermore, the method includes communicating the power demand set-points of the wind power generation system and the PV power generation system respectively to at least one of the wind power controller and the PV power controller for use in controlling operation of the wind power generation system and the PV power generation system for generation of an electrical power corresponding to the hybrid-level power demand.

In accordance with one embodiment of the present invention, a hybrid level control system for operating a hybrid power generation system is presented. The hybrid power generation system includes a wind power generation system and a PV power generation system. The hybrid level control system includes a wind power controller operably coupled to the wind power generation system. The hybrid level control system further includes a PV power controller operably coupled to the PV power generation system. The hybrid level control system also includes a hybrid controller operatively coupled to the wind power controller and the PV power controller, integrated within the wind power controller and operably coupled to the PV power controller, or integrated within the PV power controller and operably coupled to the wind power controller. The hybrid controller is configured to determine a hybrid-level power demand of the hybrid power generation system. The hybrid controller is further configured to determine respective power demand set-points of the wind power generation system and the PV power generation system based at least in part on the hybrid-level power demand. Furthermore, the hybrid controller is configured to provide the power demand set-points of the wind power generation system and the PV power generation system respectively to the wind power controller and the PV power controller for use in controlling operation of the wind power generation system and the PV power generation system for generation of an electrical power corresponding to the hybrid-level power demand.

In accordance with one embodiment of the present invention, a farm level control system for operating a farm is presented. The farm includes a plurality of hybrid power generation systems. The farm level control system includes hybrid controllers, each operatively coupled to a corresponding one of the plurality of hybrid power generation systems. The farm level control system further includes a farm level supervisory controller operatively coupled to the hybrid controllers. The farm level supervisory controller is configured to determine a farm level power demand. The farm level supervisory controller is further configured to calculate a hybrid-level power demand of each of the hybrid power generation systems based on at least one of the farm level power demand and at least one of a respective rated power, a respective possible power production metric, and a respective remaining life-time of each respective hybrid power generation system hybrid power generation systems. Furthermore, the farm level supervisory controller is configured to communicate the hybrid-level power demands to the respective hybrid controllers to enable generation of an electrical power by the hybrid power generation systems corresponding to the hybrid-level power demand.

### DRAWINGS

These and other features, aspects, and advantages of the present specification will become better understood when the following detailed description is read with reference to the accompanying drawings in which like characters represent like parts throughout the drawings, wherein:

FIG. 1 is a block diagram representation of a hybrid power generation system in accordance with one embodiment of the present invention;

FIG. 2 is a block diagram representation of a farm having a plurality of hybrid power generation systems in accordance with one embodiment of the present invention;

FIG. 3 is a block diagram representation of a farm having a plurality of hybrid power generation systems in accordance with another embodiment of the present invention;

FIG. 4 is a flow diagram of a method for operating a hybrid power generation system in accordance with one embodiment of the present invention;

FIG. 5 is a flow diagram of a method for determining a hybrid-level power demand in accordance with the embodiment of FIG. 2;

FIG. 6 is a flow diagram of a method for determining a hybrid-level power demand in the configuration of the farm of FIG. 3, in accordance with the embodiment of FIG. 3;

FIG. 7 is a flow diagram of a method for determining hybrid-level power demand in accordance with the embodiment of FIG. 3;

FIG. 8 is a flow diagram of a method for determining power demand set-points of a wind power generation system and a PV power generation system of a hybrid power generation system in accordance with one embodiment of the present invention; and

FIG. 9 is a flow diagram of a method for determining power demand set-points of a wind power generation system and a PV power generation system of a hybrid power generation system in accordance with one embodiment of the present invention.

### DETAILED DESCRIPTION

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

In accordance with some embodiments of the present invention, a method for operating a hybrid power generation system is presented. The hybrid power generation system includes a wind power generation system coupled to a wind power controller and a photo-voltaic (PV) power generation system coupled to a PV power controller. The method includes determining a hybrid-level power demand of the hybrid power generation system. The method further includes determining respective power demand set-points of the wind power generation system and the PV power generation system based at least in part on the hybrid-level power demand. Furthermore, the method includes communicating the power demand set-points of the wind power generation system and the PV power generation system respectively to at least one of the wind power controller and the PV power controller. Moreover, the method also includes using the power demand set-points of the wind power controller and the PV power controller to control operation of the wind power generation system and the PV power generation system for generation of an electrical power corresponding to the hybrid-level power demand. In accordance with some embodiments of the present invention, a hybrid level control system for operating the hybrid power generation system and a farm level control system for operating the farm are also presented.

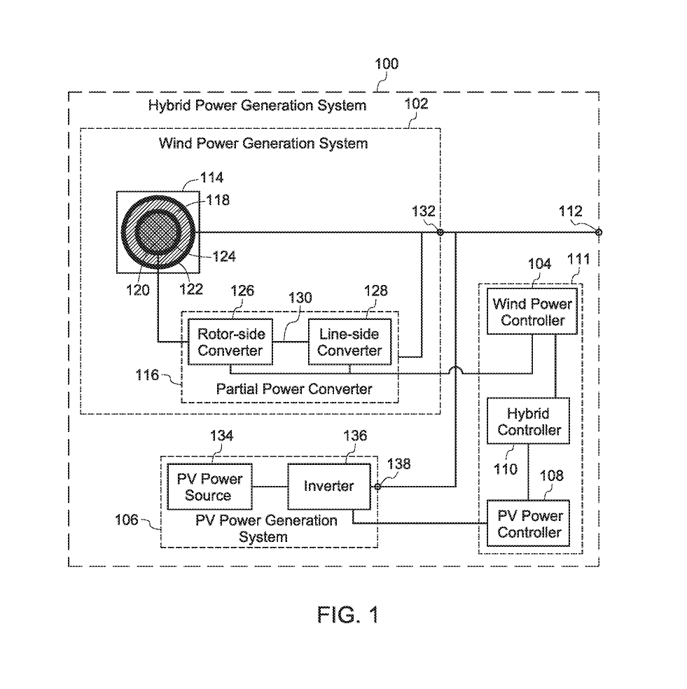

FIG. 1 is a block diagram representation of a hybrid power generation system 100 in accordance with one embodiment of the present invention. The hybrid power generation system 100 includes a wind power generation system 102, a wind power controller 104 operatively coupled to the wind power generation system 102, a photo-voltaic (PV) power generation system 106, a PV power controller 108 operatively coupled to the PV power generation system 106, and a hybrid controller 110. In the illustrated embodiment, the wind power controller 104, the PV power controller 108, and the hybrid controller 110 together form a hybrid level control system 111. In the embodiment of FIG. 1, the hybrid controller 110 is operatively coupled to the wind power controller 104 and the PV power controller 108. In some embodiments, the hybrid controller 110 may be integrated within the wind power controller 104 and operably coupled to the PV power controller 108. In certain embodiments, the hybrid controller 110 may be integrated within the PV power controller 108 and operably coupled to the wind power controller 104.

The hybrid power generation system 100 is configured to generate an alternating current (AC) electrical power and supply the AC electrical power from an output power port 112 of the hybrid power generation system 100. The AC electrical power at the output power port 112 may be single phase or multi-phase such as three-phase electrical power. Moreover, the AC electrical power generated by the hybrid power generation system 100 includes a hybrid-level active power and a hybrid-level reactive power.

The wind power generation system 102 may include, for example, a generator such as a doubly-fed induction generator (DFIG) 114 and a partial power converter 116 electrically coupled to the DFIG 114. The DFIG 114 includes a stator 118, a rotor 120, a stator winding 122 wound on the stator 118, and a rotor winding 124 wound on the rotor 120. In some embodiments, both the stator winding 122 and the rotor winding 124 may be multi-phase winding such as a three-phase winding. Although, the wind power generation system 102 having the DFIG 114 is shown in FIG. 1, a wind power generation system having other synchronous or asynchronous generator may also be used without limiting the scope of the present invention.

The DFIG 114 is mechanically coupled to a wind-turbine (not shown). For example, the rotor 120 of the DFIG 114 is mechanically coupled to a rotor of the wind-turbine such that rotations of the rotor of the wind-turbine cause rotations of the rotor 120 of the DFIG 114. The rotor 120 of the DFIG 114 is operated at a rotational speed which can be a synchronous speed, a sub-synchronous speed, or a super-synchronous speed depending on the wind speed and a slip value of the DFIG 114. During operation, the DFIG 114 is configured to generate electrical power at the stator winding 122. Further, the DFIG 114 is configured to generate or absorb electrical power at the rotor winding 124 depending on the rotational speed of the rotor 120. For example, the DFIG 114 is configured to generate electrical power at the rotor winding 124 when the rotor 120 is operated at a super-synchronous speed. The DFIG 114 is configured to absorb the electrical power at the rotor winding 124 when the rotor 120 is operated at a sub-synchronous speed. At a synchronous speed, no power is absorbed or generated at the rotor winding 124.

The partial power converter 116 is electrically coupled to the rotor winding 124 and the stator winding 122. The partial power converter 116 includes a rotor-side converter 126 and a line-side converter 128. The rotor-side converter 126 is electrically coupled to the rotor winding 124 of the DFIG 114. The line-side converter 128 is electrically coupled directly or via a transformer to the stator winding 122 of the DFIG 114. The rotor-side converter 126 and the line-side converter 128 are electrically coupled to each other via a DC-link 130. The rotor-side converter 126 may be an AC-DC converter and configured to convert an AC power into a DC power. In another embodiment, the rotor-side converter 126 may be a DC-AC converter. The line-side converter 128 may be a DC-AC converter and configured to convert the DC power into an AC power. In another embodiment, the line-side converter 128 may be a AC-DC converter.

Further, the stator winding 122 is coupled to an output electrical node 132 of the wind power generation system 102. In some embodiments, the stator winding 122 is coupled to an output electrical node 132 via a transformer (not shown). Further, the line-side converter 128 is coupled to the output electrical node 132 via a transformer (not shown). The power generated at the stator winding 122, is supplied directly or via the line-side converter to the output electrical node 132. When the rotor 120 is operated at a super-synchronous speed, the power generated at the rotor winding 124, is supplied to the output electrical node 132 via the partial power converter 116. The electrical power at the output electrical node 132 is equal to a sum of the electrical power received from the stator winding 122 and the rotor winding 124. The wind power generation system 102 supplies the generated electrical power to the output power port 112 via the output electrical node 132.

The wind power controller 104 is operatively coupled to the rotor-side converter 126 and the line-side converter 128 and configured to send control signals to the rotor-side converter 126 and the line-side converter 128 to control respective operations. More particularly, the wind power controller 104 sends the control signals to the rotor-side converter 126 and the line-side converter 128 based at least in part on instructions/control signals received from the hybrid controller 110.

The PV power generation system 106 includes a PV power source 134 and an inverter 136 coupled to the PV power source 134. The PV power source 134 includes one or more PV arrays (not shown), where each PV array may include at least one PV module (not shown). A PV module includes a suitable arrangement of a plurality of PV cells. The PV power source 134 is configured to supply the electrical power to the inverter 136. The inverter 136 is configured to convert the DC power received from the PV power source 134 into an AC power at an output electrical node 138 of the PV power generation system 106. The output electrical node 138 of the PV power generation system 106 is electrically coupled to the output electrical node 132 of the wind power generation system 106.

The PV power controller 108 is operatively coupled to the inverter 136 and configured to send control signals to the inverter 136 to control operation of the inverter 136. More particularly, the PV power controller 108 sends the control signals to the inverter 136 based at least in part on instructions/control signals received from the hybrid controller 110.

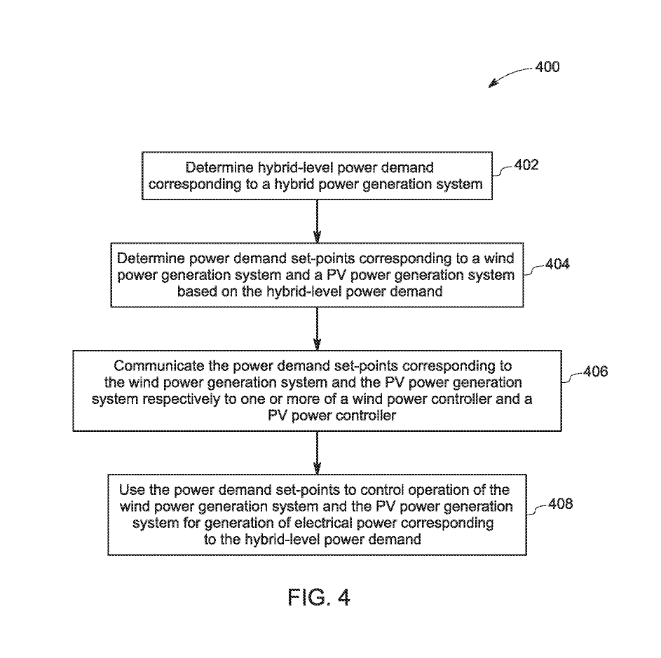

The hybrid controller 110 is configured to send control signals to the wind power controller 104 and the PV power controller 108 to control electrical power generated by the wind power generation system 102 and the PV power generation system 106. More particularly, the hybrid controller 110 is configured to communicate control signals to the wind power controller 104 and the PV power controller 108 to control production of the active and/or reactive electrical power by the wind power generation system 102 and the PV power generation system 106. Further details of the operations performed by the hybrid controller 110 are described in conjunction with methods of FIGS. 4, 5, 8, and 9.

In some embodiments, at least one among the wind power controller 104, the PV power controller 108, and the hybrid controller 110 may include a specially programmed general purpose computer, an electronic processor such as a microprocessor, a digital signal processor, and/or a microcontroller. Further, at least one of the wind power controller 104, the PV power controller 108, and the hybrid controller 110 may include input/output ports, and a storage medium, such as an electronic memory. Various examples of the microprocessor include, but are not limited to, a reduced instruction set computing (RISC) architecture type microprocessor or a complex instruction set computing (CISC) architecture type microprocessor. Further, the microprocessor may be a single-core type or multi-core type. Alternatively, at least one of the wind power controller 104, the PV power controller 108, and the hybrid controller 110 may be implemented as hardware elements such as circuit boards with processors or as software running on a processor such as a commercial, off-the-shelf personal computer (PC), or a microcontroller.

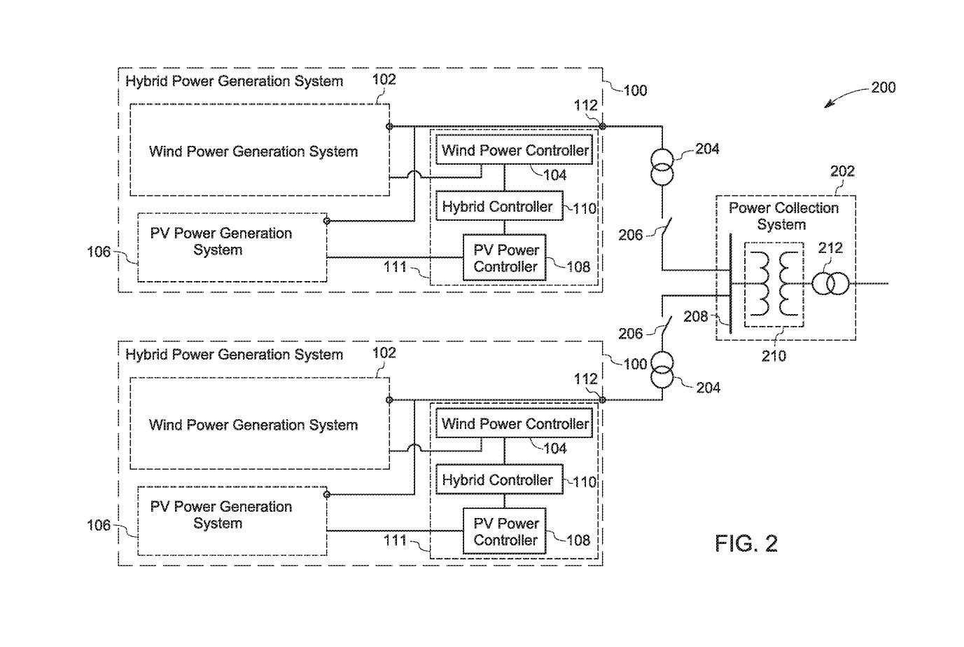

FIG. 2 is a block diagram representation of a farm 200 having a plurality of hybrid power generation systems 100 in accordance with one embodiment of the present invention. The farm 200 may be electrically coupled to an electric grid (not shown) and/or local electrical load (not shown) and configured to supply electrical power thereto.

Although, two hybrid power generation systems 100 are shown in FIG. 2, the number of hybrid power generation systems 100 may vary depending on the application.

The farm 200 additionally includes a power collection sub-system 202 electrically coupled to the plurality of hybrid power generation systems 100. The output power port 112 of each of the plurality of hybrid power generation systems 100 is coupled to the power collection sub-system 202 via a hybrid-level transformer 204 (also referred to as a pad-mount transformer) and a switch 206. The switch 206 is operated to selectively connect or disconnect the respective hybrid power generation system 100. In some embodiments, the switch 206 may be electronically controllable by the hybrid controller 110 of the respective hybrid power generation system 100. In certain other embodiments, the switch 206, may be controlled manually. The electrical power generated by the hybrid power generation systems 100 is supplied to the power collection sub-system 202 via the respective hybrid-level transformer 204 and the switch 206.

The power collection sub-system 202 includes a power bus 208, a sub-station transformer 210 coupled to the power bus 208, and a current and potential transformer (CTPT) 212 coupled to the sub-station transformer 210. The power bus 208 is electrically coupled to the output power port 112 of each of the plurality of hybrid power generation systems 100 to receive electrical power therefrom.

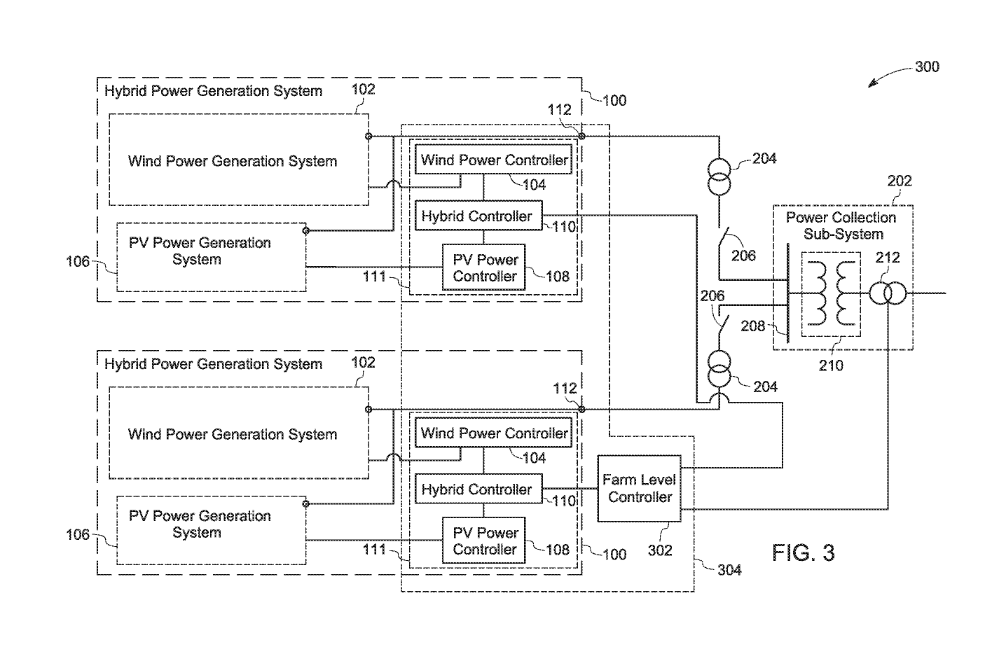

FIG. 3 is a block diagram representation of a farm 300 having the plurality of hybrid power generation systems 100 in accordance with another embodiment of the present invention. The farm 300 is similar to the embodiment of FIG. 2, except that the farm 300 additionally includes a farm level supervisory controller 302. In the illustrated embodiment, the farm level supervisory controller 302 and the hybrid level control system 111 of each of the hybrid power generation systems 100, form a farm level control system 304.

In some embodiments, the farm level supervisory controller 302 includes a specially programmed general purpose computer, an electronic processor such as a microprocessor, a digital signal processor, and/or a microcontroller. The farm level supervisory controller 302 may include input/output ports, and a storage medium, such as an electronic memory. Various examples of the microprocessor include, but are not limited to, a reduced instruction set computing (RISC) architecture type microprocessor or a complex instruction set computing (CISC) architecture type microprocessor. Further, the microprocessor may be a single-core type or multi-core type. Alternatively, the farm level supervisory controller 302 may be implemented as hardware elements such as circuit boards with processors or as software running on a processor such as a commercial, off-the-shelf personal computer (PC), or a microcontroller.

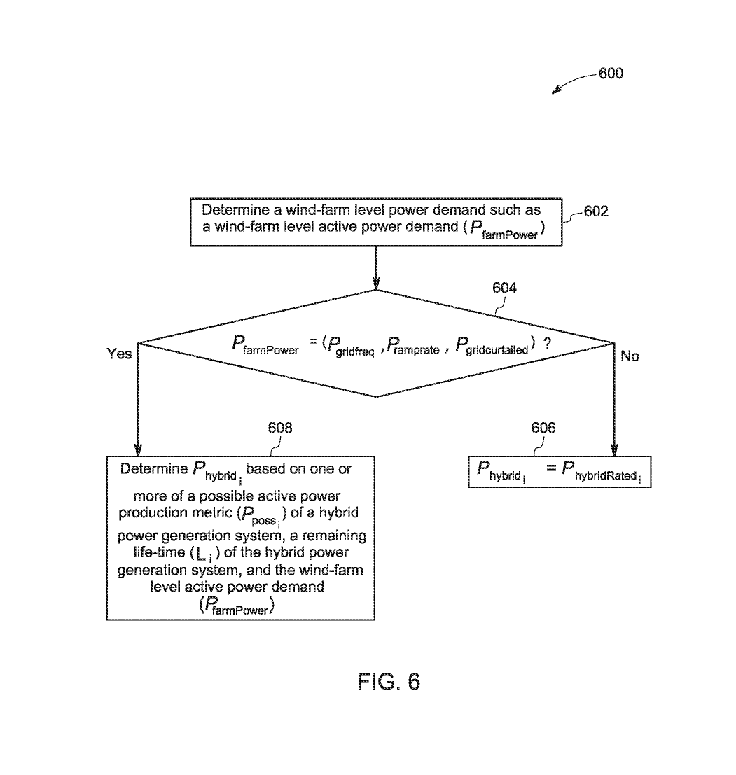

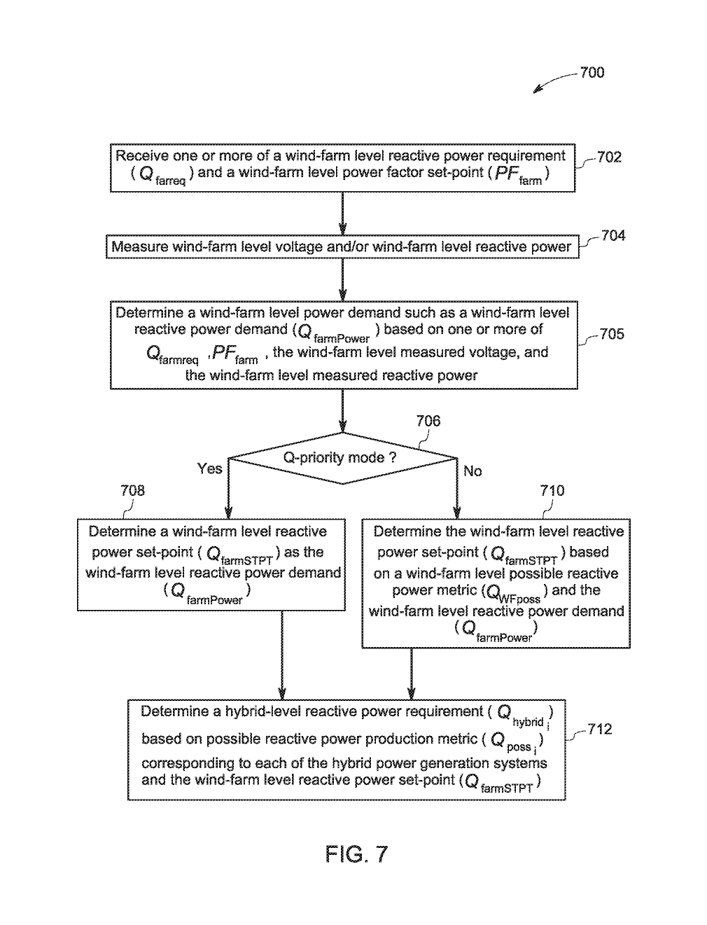

The farm level supervisory controller 302 is operatively coupled to the hybrid controller 110 of each of the plurality of hybrid power generation systems 100 and the current and potential transformer 212. The farm level supervisory controller 302 is configured to send control signals to the hybrid controllers 110 to control production of electrical power by the respective hybrid power generation systems 100. More particularly, the farm level supervisory controller 302 is configured to send control signals to the hybrid controllers 110 to control production of active and/or reactive electrical power by the respective hybrid power generation systems 100. Further details of the operation performed by the farm level supervisory controller 302 are described in conjunction with methods described below with reference to FIGS. 6 and 7.

FIG. 4 is a flow diagram 400 of a method for operating the hybrid power generation system 100 in accordance with the embodiment of FIG. 1. The method includes steps 402-408.

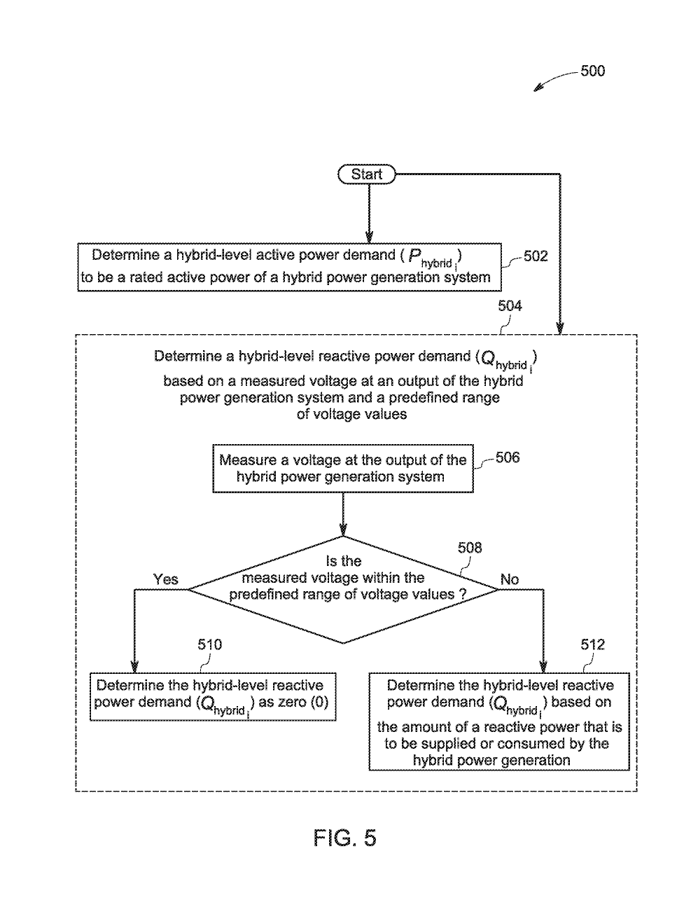

At step 402, a hybrid-level power demand of the hybrid power generation 100 is determined. In some embodiments, the hybrid controller 110 is configured to determine the hybrid-level power demand. The term “hybrid-level power demand” is referred to as a quantity of electrical power requirement from the hybrid power generation system 100. The hybrid-level power demand includes at least one of a hybrid-level active power demand (P_{hybrid}_{ᵢ}) and a hybrid-level reactive power demand (Q_{hybrid}_{ᵢ}). Further, details of determining the hybrid-level active and/or reactive power demands are described in conjunction with FIGS. 5, 6, and 7.

Further, at step 404, power demand set-points of the wind power generation system 102 and the PV power generation system 106 are determined based on the hybrid-level power demand. The term “power demand set-point” is referred to as an amount of electrical power requirement from each of the wind power generation system 102 and the PV power generation system 106.

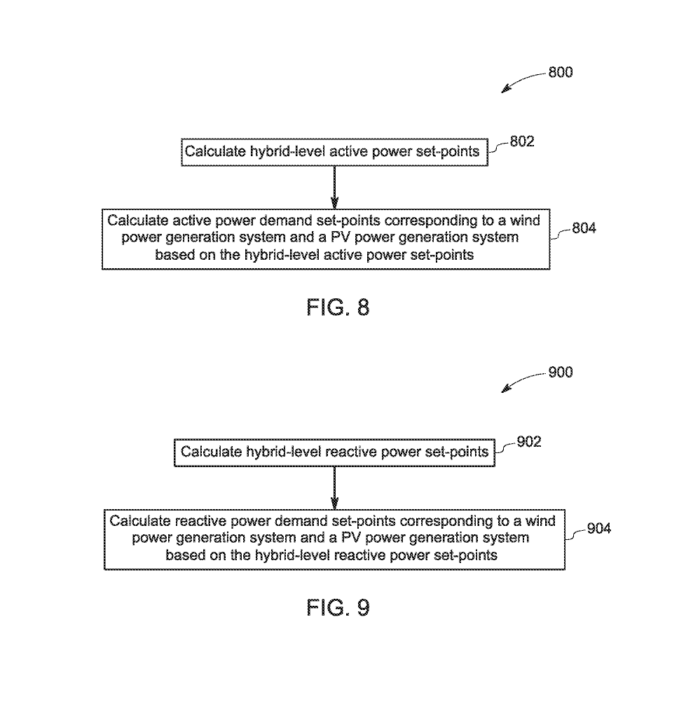

In some embodiments, the power demand set-points include an active power demand set-point of the wind power generation system 102 and an active power demand set-point of the PV power generation system 106. The hybrid controller 110 determines the active power demand set-points of the wind power generation system 102 and the PV power generation system 106 based on the hybrid-level active power demand (P_{hybrid}_{ᵢ}). Further details of determining the active power demand set-points of the wind power generation system 102 and the PV power generation system 106 are described below with reference to FIG. 8.

In some embodiments, the power demand set-points include a reactive power demand set-point of the wind power generation system 102 and a reactive power demand set-point of the PV power generation system 106. The hybrid controller 110 determines the reactive power demand set-points of the wind power generation system 102 and the PV power generation system 106 based on the hybrid-level reactive power demand (Q_{hybrid}_{ᵢ}). Further details of determining the reactive power demand set-points of the wind power generation system 102 and the PV power generation system 106 are described in detail with reference to FIG. 9.

In some embodiments, the hybrid controller 110 determines both the active power demand set-points and the reactive power demand set-points of the wind power generation system 102 and the PV power generation system 106. In some embodiments, the respective power demand set-points are determined such that the electrical power generated by the hybrid power generation system 100 does not lead to violation of predefined Balance of Plant (BoP) limits of the hybrid-level transformer 204. The BoP limits include at least one of a maximum active power limit of the hybrid-level transformer 204, a maximum apparent power limit of the hybrid-level transformer 204, a maximum apparent current limit of the hybrid-level transformer 204, a maximum temperature limit of the hybrid-level transformer 204.

At step 406, the power demand set-points of the wind power generation system 102 and the PV power generation system 106 are communicated respectively to of the wind power controller 104 and the PV power controller 108. For example, the active power demand set-point and/or the reactive power demand set-point of the wind power generation system 102 are communicated to the wind power controller 104 by the hybrid controller 110. Similarly, the active power demand set-point and/or the reactive power demand set-point of the PV power generation system 106 are communicated to the PV power controller 108 by the hybrid controller 110 for use in controlling operation of the wind power generation system 102 and the PV power generation system 106 for generation of an electrical power corresponding to the hybrid-level power demand (P_{hybrid}_{ᵢ} and/or Q_{hybrid}_{ᵢ}).

In some embodiments, the wind power controller 104 and the PV power controller 108 may be operated in a master-slave configuration with one of the wind power controller or the PV power controller acting as the hybrid controller. For example, in an embodiment, if the wind power controller 104 is configured to execute the steps 402, 404, the wind power controller 104 is further configured to communicate, at step 406, the active power demand set-point and/or the reactive power demand set-point of the PV power generation system 106 to the PV power controller 108. In another embodiment, if the PV power controller 108 is configured to execute the steps 402, 404, the PV power controller 108 is further configured to communicate, at step 406, the active power demand set-point and/or the reactive power demand set-point of the wind power generation system 102 to the wind power controller 104.

At step 408, the power demand set-points are used by wind power controller 104 and the PV power controller 108 to control operation of the wind power generation system 102 and the PV power generation system 106 respectively for generation of the electrical power corresponding to the hybrid-level power demand. For example, the wind power controller 104 and the PV power controller 108 sends control signals respectively to the partial power converter 116 and the inverter 136 to control production of electrical power by the wind power generation system 102 and the PV power generation system 106.

FIG. 5 is a flow diagram 500 of a method for determining the hybrid-level power demand in accordance with the embodiment of FIG. 2. The flow diagram 500 includes steps 502-512 that are representative of sub-steps of the step 402 of FIG. 4.

As previously noted, the hybrid-level power demand includes at least one of the hybrid-level active power demand (P_{hybrid}_{ᵢ}) and the hybrid-level reactive power demand (Q_{hybrid}_{ᵢ}). Typically, a power generation system such as the hybrid power generation system 100 has a rated active power which is dependent on power ratings of components of the hybrid power generation system 100. In one embodiment, the value of the rated active power of the hybrid power generation system 100 may be stored in a memory associated with the hybrid controller 110. At step 502, the hybrid-level active power demand (P_{hybrid}_{ᵢ}) is determined to be the rated active power of the hybrid power generation system 100.

In some embodiments, additionally or alternatively, at step 504, the hybrid controller 110 determines the hybrid-level reactive power demand (Q_{hybrid}_{ᵢ}) based on, for example, a measured voltage at an output of the hybrid power generation system 100 and a predefined range of voltage values. At step 506, a voltage is measured at the output of the hybrid power generation system 100. In one embodiment, the voltage is measured at the hybrid-level transformer 204.

Typically, it is desirable that the measured voltage at the output of the hybrid power generation system 100 is maintained within the predefined range of voltage values to ensure generation of stable voltage. Accordingly, a check may be performed at step 508 to determine whether the measured voltage is within the predefined range of voltage values. If it is determined that the measured voltage is within the predefined range of voltage values, in one embodiment, the hybrid controller 110 determines the hybrid-level reactive power demand (Q_{hybrid}_{ᵢ}) to be zero as indicated by step 510. If it is determined that the measured voltage is not within the predefined range of voltage values, the hybrid controller 110 determines an amount of the reactive power to be supplied or consumed by the hybrid power generation system 100. Accordingly, at step 512, the hybrid-level reactive power demand (Q_{hybrid}_{ᵢ}) is determined based on the amount of the reactive power needed to be supplied or consumed by the hybrid power generation 100. If the measured voltage at the output of the hybrid power generation system 100 is less than a lower limit of the predefined range of voltage values, the hybrid power generation system 100 supplies the reactive power to the power collection sub-system 202. In such an instance, the hybrid-level reactive power demand (Q_{hybrid}_{ᵢ}) representative of the reactive power to be supplied to the power collection sub-system 202 may be calculated using the following equation (1), for example:

Q_{hybrid}_{ᵢ}=k₀+k₁(ν_{low}−νₘₑₐₛ) (1)

where, k₀ represents a hybrid power offset, k₁ represents a hybrid voltage multiplier, ν_{low} represents the lower limit of the predefined range of voltage values, and νₘₑₐₛ represents the measured voltage at the output of the hybrid power generation system 100.

If the measured voltage at the output of the hybrid power generation system 100 is greater than an upper limit of the predefined range of voltage values, the hybrid power generation system 100 consumes the reactive power from the power collection sub-system 202. In such an instance, the hybrid-level reactive power demand (Q_{hybrid}_{ᵢ}) representative of the reactive power to be consumed from the power collection sub-system 202 may be calculated using the following equation (2), for example:

Q_{hybrid}_{ᵢ}=k₀+k₁(ν_{high}−νₘₑₐₛ) (2)

where, ν_{high} represents the upper limit of the predefined range of voltage values.

In some embodiments, when the measured voltage at the output of the hybrid power generation system 100 is within the predefined range of voltage values, the reactive power to be supplied to the power collection sub-system 202 may be determined to be equal to k₀. In certain embodiments, k₀=0.

FIG. 6 is a flow diagram 600 of a method for determining hybrid-level power demand in in accordance with the embodiment of FIGS. 3 and 4. The flow diagram 600 includes steps 602-608 that are representative of sub-steps of the step 402 of FIG. 4. More particularly, the flow diagram 600 is a method for determining hybrid-level active power demand (P_{hybrid}_{ᵢ}). The steps 602-608 are executed by the farm level supervisory controller 302 of FIG. 3.

At step 602, farm level active power demand (P_{farmPower}) is determined by the farm level supervisory controller 302. The farm level active power demand (P_{farmpower}) is determined based on at least one of a farm level rated active power (P_{farmrated}), a farm level measured active power (P_{farmmeas}), and one or more constraints such as but not limited to, a grid frequency constraint, a power ramp-rate limit, and a grid curtailment requirement. The term “farm level rated active power” refers to a maximum active power production capacity of the farm 300. The information of the farm level rated active power (P_{farmrated}) may be stored in a memory associated with the farm level supervisory controller 302. The farm level measured active power (P_{farmmeas}) refers to an active power measured at an output, for example, CTPT 212 of the farm 300.

In some embodiments, the active power generated from the farm 300 is based on certain constraints or requirements such as the grid frequency constraint, power ramp-rate limit, and grid curtailment requirement. The grid frequency constraint is representative of a grid frequency tolerance range requiring an output frequency of a voltage of the farm 300 to be in the grid frequency tolerance range. The output active power of the farm 300 is adjusted (i.e., increased or decreased) depending on the grid frequency tolerance range. Such an adjusted active power due to the grid frequency constraint is hereinafter referred to as a grid frequency limited active power (P_{gridfreq}).

The term “power ramp-rate limit” as used herein is indicative of a constraint on a ramp-rate for increasing or decreasing output power of the farm 300. For example, the output power of the farm 300 may not be varied beyond the power ramp-rate limit. The output power of the farm 300 which is limited due to the power ramp-rate limit, is referred to as a ramp-rate limited power (Pᵣₐₘₚᵣₐₜₑ).

In certain embodiments, there are instructions (i.e., the grid curtailment requirement) from a grid operator to limit the output power of the farm 300. In case the output power of the farm 300 is limited due to such grid curtailment requirement, such output power of the farm 300 is referred to as a grid curtailed power (P_{gridcurtai led}).

Accordingly, in some embodiments, the farm level active power demand (P_{farmPower}) may be represented by following equation (3):

P_{farmPower}=min(P_{farmrated},P_{gridfreq},Pᵣₐₘₚᵣₐₜₑ,P_{gridcurtai led}) (3)

Moreover, in some embodiments, a check may be performed at step 604 to determine if the farm level active power demand (P_{farmPower}) is selected from any of the grid frequency limited active power (P_{gridfeq}), the ramp-rate limited power (Pᵣₐₘₚᵣₐₜₑ), the grid curtailed power (P_{gridcurtai led}). If it is determined that the farm level active power demand (P_{farmPower}) is not selected from any of the grid frequency limited active power (P_{gridfeq}), the ramp-rate limited power (Pᵣₐₘₚᵣₐₜₑ) the grid curtailed power (P_{gridcurtai led}), at step 606, the farm level supervisory controller 302 determines a hybrid-level active power demand (P_{hybrid}_{ᵢ}) as the rated active power of the given hybrid power generation system 100 (P_{hybridRate d}_{ᵢ}).

If it is determined that the farm level active power demand (P_{farmPower}) is selected from any of the grid frequency limited active power (P_{gridfreq}), the ramp-rate limited power (Pᵣₐₘₚᵣₐₜₑ), the grid curtailed power (P_{gridcurtai led}), at step 608, the farm level supervisory controller 302 is determines the hybrid-level active power demand (P_{hybrid}_{ᵢ}) of the hybrid power generation system 100 based on at least one of a possible active power production metric (Pₚₒₛₛ_{ᵢ}) of the hybrid power generation system 100, a remaining life-time (Lᵢ) of the hybrid power generation system 100, and the farm level active power demand (P_{farmPower}). The term “possible active power production metric” of the hybrid power generation system 100 as used herein refers to an amount of an active power that can be possibly produced by the hybrid power generation system 100. The hybrid-level active power demand (P_{hybrid}_{ᵢ}) may be calculated using the following equation (4), for example:

P_{hybrid}_{ᵢ}=P_{farmPower}*αᵢ (4)

where αᵢ represents a farm-level active power distribution coefficient and i represents number of hybrid power generation systems 100 in the farm 300. For farm 300, i=1, 2.

In some embodiments, the farm-level active power distribution coefficient αᵢ for a hybrid power generation system is determined based on the possible active power production metric (Pₚₒₛₛ_{ᵢ}) of the hybrid power generation systems 100 in the farm 300. In some embodiments, the farm-level active power distribution coefficient αᵢ is calculated using the following equation (5):

$${α}_{i} = \frac{{P}_{{poss}_{i}}}{{\sum }_{i} {P}_{{poss}_{i}}} \qquad ( 5 )$$

Where, i=1,2 for the farm 300.

In some embodiments, the farm-level active power distribution coefficient αᵢ for the hybrid power generation system 100 is determined based on the possible active power production metric (Pₚₒₛₛ_{ᵢ}) and the remaining life-time (Lᵢ) of the hybrid power generation systems 100 in the farm 300. The farm-level active power distribution coefficient αᵢ is calculated using the following equation (6):

$${α}_{i} = {k}_{1} \frac{{P}_{{poss}_{i}}}{{\sum }_{i} {P}_{{poss}_{i}}} + {k}_{2} \frac{{L}_{i}}{{\sum }_{i} {L}_{i}} \qquad ( 6 )$$

Where, i=1,2 for the farm 300 and k₁+k₂=1.

The possible active power production metrics (Pₚₒₛₛ_{ᵢ}) for the hybrid power generation systems 100 are computed by the respective hybrid controllers 110. The values of the possible active power production metrics (Pₚₒₛₛ_{ᵢ}) are communicated from the respective hybrid controllers 110 to the farm level supervisory controller 302. The hybrid controller 110 determines the possible active power production metric (Pₚₒₛₛ_{ᵢ}) of the corresponding hybrid power generation system 100 based on a possible active wind-power production metric (P_{possW}_{ᵢ}) and a possible active PV-power production metric (P_{possPV}_{ᵢ}). The details of computing the possible active wind-power production metric (P_{possW}_{ᵢ}) and the possible active PV-power production metric (P_{possPV}_{ᵢ}) are described in detail with reference to FIG. 8. The possible active power production metric (Pₚₒₛₛ_{ᵢ}) of the corresponding hybrid power generation system 100 is calculated using the following equation (7):

Pₚₒₛₛ_{ᵢ}=P_{possW}_{ᵢ}+P_{possPV}_{ᵢ} (7)

The hybrid-level active power demand (P_{hybrid}_{ᵢ}), once determined, is communicated to the respective hybrid controllers 110 to enable generation of an electrical power by the hybrid power generation systems 100 corresponding to the hybrid-level power demand.

FIG. 7 is a flow diagram 700 of another method for determining hybrid-level power demand in accordance with the embodiment of FIG. 3. In some embodiments, the flow diagram 700 includes steps 702-712 that are representative of sub-steps of the step 402 of FIG. 4. More particularly, the flow diagram 700 is representative of a method for determining hybrid-level reactive power demand (Q_{hybrid}_{ᵢ}).

At step 702, the farm level supervisory controller 302 receives at least one of a farm level reactive power requirement (Q_{farmreq}) and a farm level power factor set-point (PF_{farm}). The farm level reactive power requirement (Q_{farmreq}) and the farm level power factor set-point (PF_{farm}) are communicated to the farm level supervisory controller 302 and/or are stored in the memory associated with the farm level supervisory controller 302. Further, at step 704, the farm level supervisory controller 302 measures farm level voltage and/or farm level reactive power. The farm level measured reactive power refers to a reactive power measured at the output, for example, current and potential transformer 212, of the farm 300.

At step 705, a farm level power demand such as a farm level reactive power demand (Q_{farmPower}) is determined by the farm level supervisory controller 302. The farm level supervisory controller 302 determines the farm level reactive power demand (Q_{farmPower}) based on at least one of the farm level reactive power requirement (Q_{farmreq}), the farm level power factor set-point (PF_{farm}), and the farm level measured active power. In some embodiments, the farm level reactive power demand (Q_{farmPower}) may be determined using following equation (8):

$${Q}_{farmPower} = \sqrt{( {S}_{farm}^{2} - {P}_{farmmeas}^{2} )} \qquad ( 8 )$$

where, S_{farm} represents the farm level apparent power and P_{farmmeas} represents the farm level measured active power. Moreover, the farm level apparent power S_{farm} may be calculated using following equation (9):

$${S}_{farm} = \frac{{P}_{farmmeas}}{{PF}_{farm}} \qquad ( 9 )$$

At step 706, the farm level supervisory controller 302 performs a check to determine whether the farm 300 should operate in a Q-priority mode. The Q-priority mode is an operating mode of the farm 300 when the farm 300 is required to supply a reactive power to a grid. At step 706, if it is determined that the farm 300 should operate in the Q-priority mode, the farm level supervisory controller 302 executes step 708. At step 708, the farm level supervisory controller 302 determines a farm level reactive power set-point (Q_{farmSTPT}) as the farm level reactive power demand (Q_{farmPower}).

At step 706, if it is determined that the farm 300 is not required to operate in the Q-priority mode, the farm level supervisory controller 302 executes step 710. At step 710, the farm level supervisory controller 302 determines the farm level reactive power set-point (Q_{farmSTPT}) based on a farm level possible reactive power metric (Q_{WFposs}) and the farm level reactive power demand (Q_{farmPower}). The farm level possible reactive power metric (Q_{WFposs}) is representative of a possible reactive power which can be generated by the farm 300. In some embodiments, the farm level possible reactive power metric (Q_{WFposs}) is equal to a sum of possible reactive power production metric (Qₚₒₛₛ_{ᵢ}) corresponding to each of the hybrid power generation systems 100 of the farm 300. and is determined using following equation (10):

Q_{WFposs}=ΣᵢQₚₒₛₛ_{ᵢ} (10)

In some embodiments, the farm level reactive power set-point (Q_{farmSTPT}) is determined as minimum of the farm level possible reactive power metric (Q_{WFposs}) and the farm level reactive power demand (Q_{farmPower}). The farm level reactive power set-point (Q_{farmSTPT}) is determined using following equation (11):

Q_{farmSTPT}=min(Qₚₒₛₛ_{ᵢ},Q_{farmpower}) (11)

After farm level reactive power set-point (Q_{farmSTPT}) is determined, at step 712, the farm level supervisory controller 302, determines a hybrid-level reactive power demand (Q_{hybrid}_{ᵢ}). The farm level supervisory controller 302 determines the hybrid-level reactive power demand (Q_{hybrid}_{ᵢ}) based on the possible reactive power production metric (Qₚₒₛₛ_{ᵢ}) corresponding to each of the hybrid power generation systems 100 in the farm 300 and the farm level reactive power set-point (Q_{farmSTPT}). The hybrid-level reactive power requirement (Q_{hybrid}_{ᵢ}) is determined using following equation (12):

Q_{hybrid}_{ᵢ}=Q_{farmSTPT}*βᵢ (12)

where, βᵢ represents a farm-level reactive power distribution coefficient and i represents number of hybrid power generation systems 100 in the farm 300. For farm 300, i=1, 2.

The farm-level reactive power distribution coefficient βᵢ for a hybrid power generation system 100 is determined based on the possible reactive power production metric (Qₚₒₛₛ_{ᵢ}) corresponding to the hybrid power generation systems 100 in the farm 300. In some embodiments, the farm-level reactive power distribution coefficient βᵢ is calculated using the following equation (13):

$${β}_{i} = \frac{{Q}_{{poss}_{i}}}{{\sum }_{i} {Q}_{{poss}_{i}}} \qquad ( 13 )$$

Where, i=1, 2 for the farm 300.

The hybrid-level reactive power demand (Q_{hybrid}_{ᵢ}), once determined, is communicated to the respective hybrid controllers 110 to enable generation of an electrical power by the hybrid power generation systems 100 corresponding to the hybrid-level power demand.

FIG. 8 is a flow diagram 800 of a method for determining power demand set-points of the wind power generation system 102 and the PV power generation system 106 in the hybrid power generation system 100 in accordance with the embodiment of FIGS. 1-3. The method includes steps 802, 804 that are representative of sub-steps of the step 404 of FIG. 4. As previously noted, the power demand set-points include the active power demand set-points and/or the reactive power demand set-points of the wind power generation system 102 and the PV power generation system 106. More particularly, the method includes steps for determining active power demand set-points corresponding to the wind power generation system 102 and the PV power generation system 106.

At step 802, a hybrid-level active power set-point (P_{hybridSTPT}) is calculated. The hybrid-level active power set-point (P_{hybridSTPT}) is determined by the hybrid controller 110 based on at least one of the hybrid-level active power demand (P_{hybrid}_{ᵢ}), an effective active power (P_{eff}_{ᵢ}) producible by the hybrid power generation system 100, rated active power (P_{hybridRate d}_{ᵢ}) of the hybrid power generation system 100. As noted earlier, in one embodiment, the hybrid-level active power demand (P_{hybrid}_{ᵢ}) may be determined by the hybrid controller 110 at step 502 of FIG. 5. In another embodiment, the hybrid-level active power demand (P_{hybrid}_{ᵢ}) may be determined by the farm level supervisory controller 302 at step 608 of FIG. 6. The effective active power (P_{eff}_{ᵢ}) is determined using following equation (14):

$${P}_{{eff}_{i}} = \sqrt{( {S}_{{hybrid}_{i}}^{2} - {Q}_{{hybrid}_{i}}^{2} )} \qquad ( 14 )$$

where S_{hybrid}_{ᵢ} represents a hybrid-level apparent power.

The hybrid-level active power set-point (P_{hybridSTPT}) is calculated using following equation (15):

P_{hybridSTPT}=mini(P_{hybrid}_{ᵢ},P_{eff}_{ᵢ},P_{hybridRated}_{ᵢ}) (15)

At step 804, the hybrid controller 110 calculates the active power demand set-points of the wind power generation system 102 and the PV power generation system 106. In some embodiments, the hybrid controller 110 calculates the active power demand set-points based on a selected power regulation mode. For example, the power regulation mode may be any of a possible power mode, a tariff mode, or speed regulation mode. In one embodiment, the selection of the power regulation mode is pre-configured. In some embodiments, the selection of the power regulation mode is performed by an operator.

In the possible power mode, the active power demand set-points of the wind power generation system 102 and the PV power generation system 106 are determined based on possible active power production metrics, for example, a possible active wind-power production metric (P_{possW}_{ᵢ}) of the wind power generation system 102, a possible active PV-power production metric (P_{possPV}_{ᵢ}) of the PV power generation system 106, and the hybrid-level active power demand set-point (P_{hybridSTPT}) determined at step 802.

The possible active power production metric (P_{possW}_{ᵢ}) is referred to as an active power that can be possibly produced by the wind power generation system 102. In some embodiments, the possible active wind-power production metric (P_{possW}_{ᵢ}) is calculated by the hybrid controller 110 based on an estimated wind velocity. The wind velocity may be estimated by the hybrid controller 110 based on at least one of a wind-turbine power, rotor speed, pitch angle of turbine blades, using a Kalman filter or extended Kalman filter. Further, a table having a mapping between the estimated wind velocity and different values of the possible active wind-power production metric (P_{possW}_{ᵢ}) is stored in the memory associated with the hybrid controller 110. The hybrid controller 110 determines the possible active wind-power production metric (P_{possW}_{ᵢ}) based on the mapping between the estimated wind velocity and the different values of the possible active wind power production metric (P_{possW}_{ᵢ}).

The possible active power production metric (P_{possPV}_{ᵢ}) is referred to as an active power that can be possibly produced by the PV power generation system 106. In some embodiments, if solar insolation data is available, the possible active PV-power production metric (P_{possPV}_{ᵢ}) is determined by the hybrid controller 110 based on at least one of the insolation data, ambient temperature, air density, and solar irradiance. In some embodiments, if the solar insolation data is not available, the hybrid controller 110 estimates the solar insolation based on at least one of voltage and current characteristics of the PV power source, the ambient temperature, and the air density. Further, the hybrid controller 110 determines the possible active PV-power production metric (P_{possPV}_{ᵢ}) based on the estimated solar insolation data.

The hybrid controller 110 calculates the active power demand set-points of the wind power generation system 102 and the PV power generation system 106 based on the possible active power production metrics (P_{possW}_{ᵢ}, P_{possPV}_{ᵢ}) and the hybrid-level active power demand set-point (P_{hybridSTPT}).

In one embodiment, the active power demand set-point (P_{WSTPT}) of the wind power generation system 102 is calculated using following equation (16):

P_{WSTPT}=P_{hybridSTPT}*μ (16)

where μ is obtained by the following equation (17):

$$μ = \frac{{P}_{{possW}_{i}}}{{P}_{{possW}_{i}} + {P}_{{possPV}_{i}}} \qquad ( 17 )$$

In one embodiment, the active power demand set-point (P_{PVSTPT}) of the PV power generation system 106 is determined using following equation (18):

P_{PVSTPT}=P_{hybridSTPT}*λ (18)

where λ is obtained by following equation (19):

$$λ = \frac{{P}_{{possPV}_{i}}}{{P}_{{possW}_{i}} + {P}_{{possPV}_{i}}} \qquad ( 19 )$$

Referring now to the tariff mode, the active power demand set-points of the wind power generation system 102 and the PV power generation system 106 are determined based on the wind power tariff and the PV power tariff. In some embodiments, the hybrid controller 110 determines the active power demand set-points (P_{WSTPT} and P_{PVSTPT}) such that active power from the power generation system having lower tariff is curtailed.

In some embodiments, if the PV power tariff is greater than the wind power tariff, the hybrid controller 110 determines the active power demand set-points (P_{WSTPT} and P_{PVSTPT}) such that active power from the wind power generation system 102 is curtailed. In such embodiments, the active power demand set-point (P_{WSTPT}) of the wind power generation system 102 is calculated by the following equation (20) and the active power demand set-point (P_{PVSTPT}) of the PV power generation system 106 is calculated by the following equation (21):

P_{WSTPT}=min(P_{w min},P_{hybrSTPT}−P_{measPV}) (20)

P_{PVSTPT}=P_{measPV}−Deficit_{P}_{_{PV>W}} (21)

wherein,
P_{W min} is representative of a minimum active power producible by the wind power generation system 102,
P_{measPV} is representative of a measured active power at an output of the PV power generation system 106, and
Deficit_{P PV>W} is representative of additional curtailment requirement if curtailment of the wind active power is not sufficient. For example, Deficit_{P}_{_{PV>W}} is determined using following equation (22):

Deficit_{P}_{_{PV>W}}=P_{WSTPT}+P_{measPV}−P_{hybridSTPT} (22)

In some embodiments, if the PV power tariff is less than the wind power tariff, the hybrid controller 110 determines the active power demand set-points (P_{WSTPT} and P_{PVSTPT}) such that electrical power from the PV power generation system 106 is curtailed. In such embodiments, the active power demand set-points P_{PVSTPT} and P_{WSTPT} is calculated using the following equations (23, 24):

P_{PVSTPT}=min(P_{PV min},P_{hybridSTPT}−P_{measW}) (23)

P_{WSTPT}=P_{measW}−Deficit_{P}_{_{PV<W}} (24)

where:
P_{PV min} is representative of a minimum active power producible by the PV power generation system,
P_{measW} is representative of a measured active power at an output of the wind power generation system, and
Deficit_{PV<W} is representative of additional curtailment requirement if curtailment of the PV active power is not sufficient. For example, Deficit_{P}_{_{PV<W}} is determined using following equation (25):

Deficit_{P}_{_{PV<W}}=P_{PVSTPT}+P_{measW}−P_{hybridSTPT} (25)

For the speed regulation mode, the rotational speed of the rotor of the wind turbine is controlled in such a way that the electrical power from the wind power generation system 102 is not over curtailed. In the speed regulation mode, the active power demand set-points P_{PVSTPT} and P_{WSTPT} are calculated using by the following equations (26, 27):

P_{PVSTPT}=max(0,mim(P_{V min},P_{measW},P_{hybridSTPT})) (26)

P_{WSTPT}=P_{hybridSTPT}−P_{PVSTPT} (27)

FIG. 9 is a flow diagram 900 of a method for determining power demand set-points of the wind power generation system 102 and the PV power generation system 106 in the hybrid power generation system 100 in accordance with the embodiments of FIGS. 1-3. The flow diagram 900 includes steps 902 and 904 that are representative of sub-steps of the step 404 of FIG. 4. More particularly, the includes steps for determining reactive power demand set-points of the wind power generation system 102 and the PV power generation system 106.

At step 902, a hybrid-level reactive power set-point (Q_{hybridSTPT}) is determined. The hybrid-level reactive power set-point (Q_{hybridSTPT}) is determined by the hybrid controller 110 based on at least one of the hybrid-level reactive power demand (Q_{hybrid}_{ᵢ}), an effective reactive power (Q_{eff}_{ᵢ}) producible by the hybrid power generation system 100, rated reactive power (Q_{hybridRate d}_{ᵢ}) of the hybrid power generation system 100. In some embodiments, the hybrid-level reactive power set-point (Q_{hybridSTPT}) is calculated using following equation (28):

Q_{hybridSTPT}=min(Q_{hybrid}_{ᵢ},Q_{eff}_{ᵢ},Q_{hybridRated}_{ᵢ}) (28)

As noted earlier, in one embodiment, the hybrid-level reactive power demand (Q_{hybrid}_{ᵢ}) may be determined by the hybrid controller 110 at steps 510 or 512 of FIG. 5. In another embodiment, the hybrid-level reactive power demand (Q_{hybrid}_{ᵢ}) may be determined by the farm level supervisory controller 302 at step 712 of FIG. 7. In some embodiments, the effective reactive power (Q_{eff}_{ᵢ}) is determined using following equation (29):

$${Q}_{{eff}_{i}} = \sqrt{( {S}_{{hybrid}_{i}}^{2} - {P}_{{meas}_{i}}^{2} )} \qquad ( 29 )$$

where S_{hybrid}_{ᵢ} represents a hybrid-level apparent power and Pₘₑₐₛ_{ᵢ} represents measured active power at the output of the hybrid power generation system 100.

Further in some embodiments, at step 904, the hybrid controller 110 is configured to calculate the reactive power demand set-points corresponding to the wind power generation system 102 and the PV power generation system 106. In some embodiments, the hybrid controller 110 is configured to calculate the reactive power demand set-points based on the selected power regulation mode described hereinabove.

For the possible power mode, the reactive power demand set-points of the wind power generation system 102 and the PV power generation system 106 are determined based on possible reactive power production metrics, for example, a possible reactive wind-power production metric (Q_{possW}_{ᵢ}) of the wind power generation system 102, a possible reactive PV-power production metric (Q_{possPV}_{ᵢ}) of the PV power generation system 106, and the hybrid-level reactive power demand set-point (Q_{hybridSTPT}).

The possible reactive power production metric (Q_{possW}_{ᵢ}) is referred to as reactive power that can be possibly generated by the wind power generation system 102. In some embodiments, the possible reactive wind-power production metric (Q_{possW}_{ᵢ}) is calculated by the hybrid controller 110 based on an estimated wind velocity. The wind velocity is estimated by the hybrid controller 110 based on at least one of a wind-turbine power, rotor speed, pitch angle of the turbine blades, using Kalman filter or extended Kalman filter. Further, a table having a mapping between the estimated wind velocity and different values of the possible reactive wind-power production metric (Q_{possW}_{ᵢ}) is stored in the memory associated with the hybrid controller 110. The hybrid controller 110 determines the possible reactive wind-power production metric (Q_{possW}_{ᵢ}) based on the mapping between the estimated wind velocity and different values of the possible reactive wind-power production metric (Q_{possW}_{ᵢ}).

The possible reactive power production metric (Q_{possPV}_{ᵢ}) is referred to as reactive power that can be possibly produced by the PV power generation system 106. In some embodiments, if solar insolation data is available, the possible reactive PV-power production metric (Q_{possPV}_{ᵢ}) is determined by the hybrid controller 110 based on at least one of the insolation data, ambient temperature, air density, and solar irradiance. In some embodiments, when the solar insolation data is not available, the hybrid controller 110 is configured to estimate the solar insolation based on one or more of voltage and current characteristics of the PV power source, the ambient temperature, the air density. Further, the hybrid controller 110 may determine the possible reactive PV-power production metric (Q_{possPV}_{ᵢ}) based on the estimated solar insolation data.

The hybrid controller 110 calculates the reactive power demand set-points of the wind power generation system 102 and the PV power generation system 106 based on the possible reactive power production metrics (Q_{possW}_{ᵢ}, Q_{possPV}_{ᵢ}) and the hybrid-level reactive power demand set-point (Q_{hybridSTPT}).

The reactive power demand set-point (Q_{WASTPT}) of the wind power generation system 102 is calculated using following equation (30):

Q_{WSTPT}=Q_{hybridSTPT}*σ (30)

where σ may be calculated using the following equation (31):

$$σ = \frac{{Q}_{{possW}_{i}}}{{Q}_{{possW}_{i}} + {Q}_{{possPV}_{i}}} \qquad ( 31 )$$

In one embodiment, the reactive power demand set-point (Q_{PVSTPT}) of the PV power generation system 106 is calculated using following equation (32):

Q_{PVSTPT}=Q_{hybridSTPT}*ϕ (32)

where ϕ is calculated using the following equation (33):

$$φ = \frac{{Q}_{{possPV}_{i}}}{{Q}_{{possW}_{i}} + {Q}_{{possPV}_{i}}} \qquad ( 33 )$$

For the tariff mode, the reactive power demand set-points of the wind power generation system 102 and the PV power generation system 106 are determined based on the wind power tariff and the PV power tariff. In some embodiments, the hybrid controller 110 determines the reactive power demand set-points such that reactive power from the power generation system having lower tariff is curtailed.

In some embodiments, if the PV power tariff is higher than the wind power tariff, the hybrid controller 110 determines the reactive power demand set-points (Q_{WSTPT} and Q_{PVSTPT}) such that reactive power from the wind power generation system 102 is curtailed. In such embodiments, the reactive power demand set-points (Q_{WSTPT} and Q_{PVSTPT}) are calculated using the following equations (34, 35):

Q_{WSTPT}=min(Q_{possW}_{ᵢ},Q_{hybridSTPT}) (34)

Q_{PVSTPT}=min(Deficit_{Q}_{_{PV>W}},Q_{possPV}_{ᵢ}) (35)

where Deficit_{Q}_{_{PV>W}} representative of additional curtailment requirement if curtailment of the reactive wind reactive power is not sufficient. For example, Deficit_{QP>W} is determined using following equation (36):

Deficit_{Q}_{_{PV>W}}=Q_{hybridSTPT}−Q_{WSTPT} (36)

In some embodiments, if the PV power tariff is less than the wind power tariff, the hybrid controller 110 determines the reactive power demand set-points (Q_{WSTPT} and Q_{PVSTPT}) such that reactive power from the PV power generation system 106 is curtailed. In such embodiments, the reactive power demand set-points Q_{WSTPT} and Q_{PVSTPT} are calculated using the following equations (37, 38).

Q_{PVSTPT}=min(Q_{possPV}_{ᵢ},Q_{hybridSTPT}) (37)

Q_{WSTPT}=min(Deficit_{Q}_{_{PV<W}},Q_{possW}_{ᵢ}) (38)

where Deficit_{Q}_{_{PV<W}} is representative of additional curtailment requirement if curtailment of the PV reactive power is not sufficient. For example, Deficit_{Q}_{_{PV<W}} is determined using following equation (39):

Deficit_{Q}_{_{PV<W}}=Q_{hybridSTPT}−Q_{WSTPT} (39)

For the speed regulation mode, the reactive power demand set-points Q_{PVSTPT} and Q_{WSTPT} are calculated using the techniques described regarding the possible power mode and the tariff mode.

Any of the foregoing steps may be suitably replaced, reordered, or removed, and additional steps may be inserted, depending on the needs of an application.

In accordance with the embodiments discussed herein, coordination between a hybrid controller and a farm level supervisory controller facilitates to distribute power demands among a plurality of hybrid power generation systems such that power demand of the farm is satisfied. In some embodiments, use of possible power production metrics for distribution of the active and reactive power demands leads to balanced distribution of power demand among the hybrid power generation systems. Similarly, use of possible power production metrics for distribution of the active and reactive power demands also leads to balanced distribution of the power demand between the wind power generation system and the PV power generation system within each hybrid power generation system.

It will be appreciated that variants of the above disclosed and other features and functions, or alternatives thereof, may be combined to create many other different applications. Various unanticipated alternatives, modifications, variations, or improvements therein may be subsequently made by those skilled in the art and are also intended to be encompassed by the following claims.

1. A method for operating a hybrid power generation system (100), the hybrid power generation system (100) comprising a wind power generation system (102) coupled to a wind power controller (104) and a photo-voltaic (PV) power generation system coupled to a PV power controller (108), the method comprising:
determining a hybrid-level power demand of the hybrid power generation system (100);
determining respective power demand set-points of the wind power generation system (102) and the PV power generation system (106) based at least in part on the hybrid-level power demand; and
communicating the power demand set-points of the wind power generation system (102) and the PV power generation system (106) respectively to at least one of the wind power controller (104) and the PV power controller (108) for use in controlling operation of the wind power generation system (102) and the PV power generation system (106) for generation of an electrical power corresponding to the hybrid-level power demand.

2. The method of claim 1, wherein the hybrid-level power demand comprises at least one of a hybrid-level active power demand and a hybrid-level reactive power demand, and wherein the power demand set-points comprise at least one of active power demand set-points and reactive power demand set-points.

3. The method of claim 2, wherein determining the hybrid-level power demand comprises using a rated active power of the hybrid power generation system (100).

4. The method of claim 2, wherein determining the hybrid-level active power demand comprises:
determining a farm level active power demand; and
calculating the hybrid-level active power demand of the hybrid power generation system (100) based on the farm level active power demand and at least one of a rated active power of the hybrid power generation system (100), a possible active power production metric of the hybrid power generation system (100), and a remaining life-time of the hybrid power generation system (100).

5. The method of claim 4, wherein the farm level active power demand is determined based on at least one of a farm level rated active power, a grid frequency, a power ramp-rate limit, a grid curtailment requirement, and a farm level measured active power.

6. The method of claim 2, wherein determining the hybrid-level reactive power demand comprises determining the hybrid-level reactive power demand based on a measured voltage at an output of the hybrid power generation system (100) and a predefined range of voltage values.

7. The method of claim 2, wherein determining the hybrid-level power demand comprises:
determining a farm level reactive power demand; and
calculating the hybrid-level reactive power demand of the hybrid power generation system (100) based on the farm level reactive power demand and at least one of a farm level reactive power demand, a possible reactive power production metric of the hybrid power generation system (100), and a remaining life-time of the hybrid power generation system (100).

8. The method of claim 7, wherein the farm level reactive power demand is determined based on at least one of a farm level reactive power requirement, a farm level power factor set-point, and a farm level measured active power.

9. The method of claim 2, wherein determining the respective power demand set-points comprises calculating the active power demand set-points of the wind power generation system (102) and the PV power generation system (106) based on at least one of possible active power production metrics, the hybrid-level active power demand, a wind power tariff, and a PV power tariff.

10. The method of claim 2, wherein determining the respective power demand set-points comprises calculating the reactive power demand set-points of the wind power generation system (102) and the PV power generation system (106) based on at least one of possible reactive power production metrics, the hybrid-level reactive power demand, a wind power tariff, and a PV power tariff.

11. The method of claim 1, wherein the hybrid power generation system (100) is electrically coupled to a power collection sub-system via a hybrid-level transformer (204), wherein the respective power demand set-points are determined such that the electrical power generated by the hybrid power generation system (100) does not lead to violation of predefined Balance of Plant (BoP) limits of the hybrid-level transformer (204), and wherein the predefined BoP limits comprises at least one of a maximum active power limit of the hybrid-level transformer (204), a maximum apparent power limit of the hybrid-level transformer (204), a maximum apparent current limit of the hybrid-level transformer (204), and a maximum temperature limit of the hybrid-level transformer (204).

12. A hybrid level control system (111) for operating a hybrid power generation system (100), wherein the hybrid power generation system (100) comprises a wind power generation system (102) and photo-voltaic (PV) power generation system, the hybrid level control system (111) comprising:
a wind power controller (104) operably coupled to the wind power generation system (102);
a PV power controller (108) operably coupled to the PV power generation system (106); and
a hybrid controller (110) operatively coupled to the wind power controller (104) and the PV power controller (108), integrated within the wind power controller (104) and operably coupled to the PV power controller (108), or integrated within the PV power controller (108) and operably coupled to the wind power controller (104), wherein the hybrid controller (110) is configured to:
determine a hybrid-level power demand of the hybrid power generation system (100);
determine respective power demand set-points of the wind power generation system (102) and the PV power generation system (106) based at least in part on the hybrid-level power demand; and
provide the power demand set-points of the wind power generation system (102) and the PV power generation system (106) respectively to the wind power controller (104) and the PV power controller (108) for use in controlling operation of the wind power generation system (102) and the PV power generation system (106) for generation of an electrical power corresponding to the hybrid-level power demand.

13. The hybrid level control system (111) of claim 12, wherein the hybrid-level power demand comprises at least one of a hybrid-level active power demand and a hybrid-level reactive power demand, and wherein the respective power demand set-points comprise at least one of active power demand set-points and reactive power demand set-points.

14. The hybrid level control system (111) of claim 13, wherein the hybrid controller (110) is configured to determine the hybrid-level active power demand by using a rated active power of the hybrid power generation system (100).

15. The hybrid level control system (111) of claim 13, wherein the hybrid controller (110) is configured to determine the hybrid-level reactive power demand based on a measured voltage at an output of the hybrid power generation system (100) and a predefined range of voltage values.

16. The hybrid level control system (111) of claim 13, wherein the hybrid controller (110) is configured to calculate the active power demand set-points of the wind power generation system (102) and the PV power generation system (106) based on at least one of possible active power production metrics, the hybrid-level active power demand, a wind power tariff, a PV power tariff.

17. The hybrid level control system (111) of claim 13, wherein the hybrid controller (110) is configured to calculate the reactive power demand set-points of the wind power generation system (102) and the PV power generation system (106) based on at least one of possible reactive power production metrics, the hybrid-level reactive power demand, a wind power tariff, a PV power tariff.

18. A farm level control system (304) for operating a farm (300) comprising a plurality of hybrid power generation systems (100), the farm level control system (304) comprising:
hybrid controllers (110), each operatively coupled to a corresponding one of the plurality of hybrid power generation systems (100); and
a farm level supervisory controller (302) operatively coupled to the hybrid controllers (110), wherein the farm level supervisory controller (302) is configured to:
determine a farm level power demand;
calculate a hybrid-level power demand of each of the hybrid power generation systems (100) based on at least one of the farm level power demand and at least one of a respective rated power, a respective possible power production metric, and a respective remaining life-time of each respective hybrid power generation system (100) hybrid power generation systems (100); and
communicate the hybrid-level power demands to the respective hybrid controllers (110) to enable generation of an electrical power by the hybrid power generation systems (100) corresponding to the hybrid-level power demand.

19. The farm level control system (304) of claim 18, wherein the farm level power demand comprises at least one of a farm level active power demand and a farm level reactive power demand, and wherein the hybrid-level power demand comprises at least one of a hybrid-level active power demand and a hybrid-level reactive power demand.

20. The farm level control system (304) of claim 19, wherein the farm level supervisory controller (302) is configured to determine the farm level active power demand based on at least one of a farm level rated active power, a grid frequency, a power ramp-rate limit, a grid curtailment requirement, and a farm level measured active power, and wherein the farm level supervisory controller (302) is configured to determine the farm level reactive power demand based on at least one of a farm level reactive power requirement, a farm level power factor set-point, a farm level measured voltage, and a farm level measured reactive power.
